(19) United States
(12) Patent Application Publication
(10) Pub. No.: US 2025/0297507 A1
(43) Pub. Date: Sep. 25, 2025

(54) FRAME PROFILE WITH MULTIFUNCTION CHANNEL FOR DOOR JAMBS

(71) Applicant: ALTRO BUILDING SYSTEMS PTY LTD, Wetherill Park, New South Wales (AU)

(72) Inventors: Gregory David HORSFALL, Wetherill Park, New South Wales (AU); Gavin John HORSFALL, Wetherill Park, New South Wales (AU); Gary DE LEON, Wetherill Park, New South Wales (AU)

(21) Appl. No.: 18/861,548

(22) PCT Filed: May 1, 2023
(86) PCT No.: PCT/AU23/50362

§ 371 Date: Oct. 29, 2024

(30) Foreign Application Priority Data
Apr. 29, 2022 (AU) 2022901130

(51) Int. Cl. E06B 1/52; E06B 1/34; E06B 1/62; E06B 1/68

(52) U.S. Cl. CPC E06B 1/526; E06B 1/34; E06B 1/68; E06B 2001/622

(57) ABSTRACT

A frame profile is an elongated extrusion having a consistent cross section along its length which can be cut to required lengths for forming side jambs and/or a head jamb of a door. The frame profile includes a base plate having a first face, a second face, a first side edge and a second side edge. There is a first formation extending from the first face adjacent the first side edge, and a second formation extending from the first face close to the second side edge. The second formation is spaced from the first formation to define a main channel therebetween. The second formation includes a trim receiving space for receiving a trim board therein.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a frame profile with a multifunction channel for door jambs.

### 2. Description of Related Art Including Information Disclosed Under 37 CFR 1.97 and 37 CFR 1.98.

A door frame assembly typically includes several parts including a head jamb (also called header or head stile), side jambs (also called legs or side stiles), a sill or threshold, and door stops (also called strike jambs). In most cases, the strikes are formed in the side jambs as stepped portions therein. The door opening is finished with a moulding called an architrave which covers the junction between the door frame assembly and the adjacent walls. The door frame assembly comes in different depths to suit different wall thicknesses.

The present invention seeks to provide a door jamb with improved installation flexibility, or which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a frame profile being an elongated extrusion having a consistent cross section along its length which can be cut to required lengths for forming side jambs and/or a head jamb of a door, the frame profile in cross-section comprising:
a base plate having a first face, a second face, a first side edge and a second side edge,
a first formation extending from the first face adjacent the first side edge,
a second formation extending from the first face close to the second side edge, the second formation being spaced from the first formation to define a main channel therebetween, and
wherein the second formation includes a trim receiving space for receiving a trim board therein.

In one embodiment, a wall attachment flange extends from the first side edge and generally perpendicularly to the second face to form a structure engagement space therebetween.

In another embodiment, the second formation is spaced from the second side edge to define an attachment tab.

In another embodiment, the first formation is generally hollow rectangular in cross-section and includes a first side extending generally perpendicularly to the first face at the first side edge, a second side extending generally perpendicularly to the first face and parallel to and spaced from the first side, and a third side extending generally between distal edges of the first side and the second side, the first formation having an extension rib along the first side thereof, the extension rib having a retaining channel for receiving a felt or rubber strip in use.

In another embodiment, the first formation defines connector first insertion apertures therein.

In another embodiment, the second formation comprises a main side which extends generally perpendicularly to the first face of the base plate, parallel to and spaced from the second side of the first formation to form the main channel therebetween.

In another embodiment, the main side is co-extensive in length from the first face as the second side of the first formation.

In another embodiment, the main side of the second formation and the second side of the first formation form the main channel therebetween with retention grooves adjacent lower portions of the main side and the second side adjacent the base plate.

In another embodiment, the second formation further comprises a hollow rectangular frame section extending from the main side and the first face.

In another embodiment, the frame section defines second insertion apertures therewithin.

In another embodiment, an extension extends laterally from the main side, parallel to the first face and towards the second side edge, the extension forming the trim receiving space with the main side and the frame section.

In another embodiment, wherein a portion of the base plate between the frame section and the second side edge defines an attachment tab.

In another embodiment, the frame profile further comprises an elongated clip-on cover having an outer side and flange legs for insertion into the main channel, the flange legs including ribs at the lower outer ends thereof which engage the retention grooves of the main channel.

The invention in another aspect provides a method of forming a side jamb and a head jamb using the frame profile of the above, the method comprising cutting sections of the elongate frame profile to the required lengths to form the side jamb and the head jamb, the ends of the frame profiles being mitre cut at 45° to form the 90° corners between the head jamb and the side jamb.

In another embodiment, corner connectors which have two legs at 90° to each other are inserted into the connector first insertion apertures and second insertion apertures to connect and align the head jamb and the side jamb.

In another embodiment, the method further comprises installing a hinge in the main channel.

In another embodiment, the method further comprises installing a latch in the main channel.

In another embodiment, the method further comprises covering the main channel with an elongated clip-on cover having an outer side and flange legs for insertion into the main channel, the flange legs including ribs at the lower outer ends thereof which engage the retention grooves of the main channel.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 shows a perspective view of a door of a structure with a door jamb assembly in accordance with a preferred embodiment of the present invention.

FIG. 2 shows an internal upper perspective view of the junction between a side jamb and a head jamb.

FIG. 3 shows an external upper perspective view of the junction between a side jamb and a head jamb.

FIG. 4 shows perspective views of the connection between a side jamb and a head jamb using corner connectors.

FIG. 5 is a cross-sectional view of a frame profile used to form the side jambs and the head jamb.

FIG. 6 is a cross-sectional view of the frame profile installed for forming a latch side jamb.

FIG. 7 is a cross-sectional view of a modified embodiment of the FIG. 6 assembly having a shorter rebate for the door.

FIG. 8 is a cross-sectional view of the frame profile installed for forming a hinge side jamb with a hinge installed thereon.

FIGS. 9 to 12 perspective views, showing attachment of a hinge to a hinge side jamb.

FIGS. 13 to 15 show perspective views of an attachment of a latch to a latch side jamb.

### DETAILED DESCRIPTION OF THE INVENTION

It should be noted in the following description that like or the same reference numerals in different embodiments denote the same or similar features.

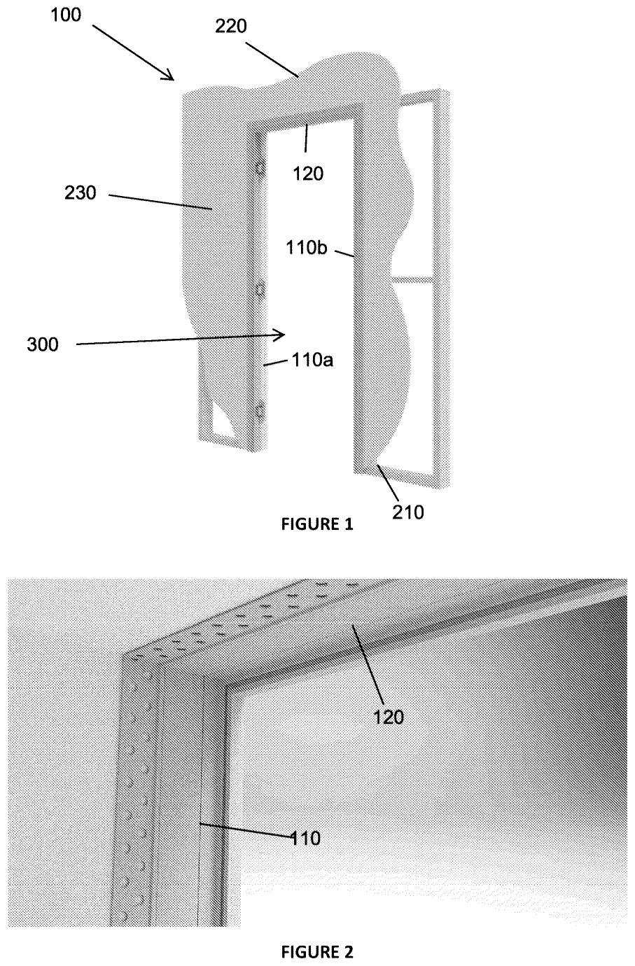

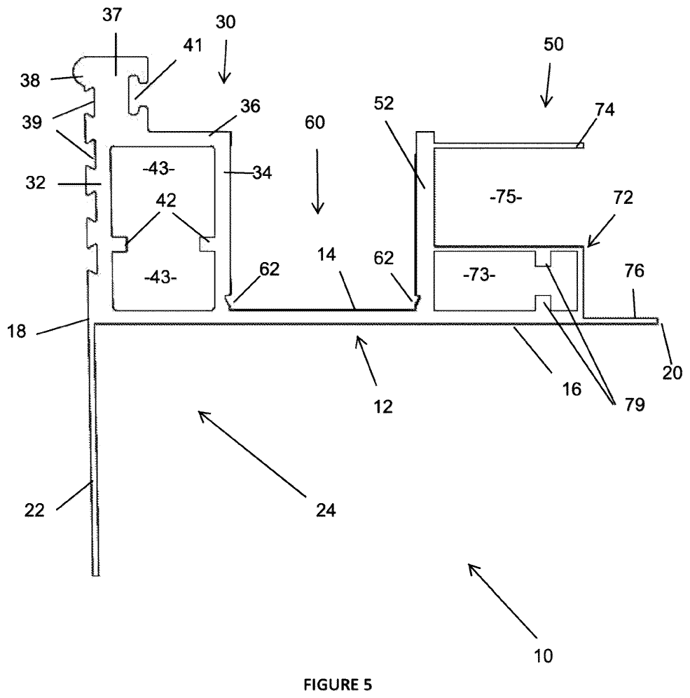

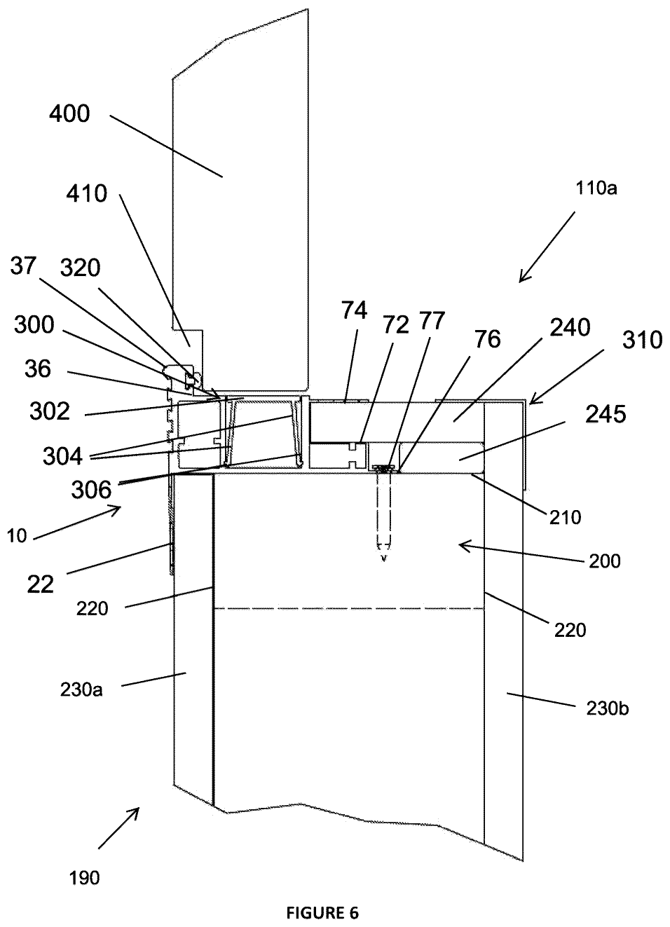

FIGS. 1 to 4 shows a door jamb assembly 100 according to a preferred embodiment of the present invention. The door jamb assembly 100 is for mounting to a door opening 300 of a building structure to form the side jambs 110 and the head jamb 120. The door opening 300 typically comprises vertical door frame studs 200 and first and second wall panels 230 mounted to side faces of the frame stud.

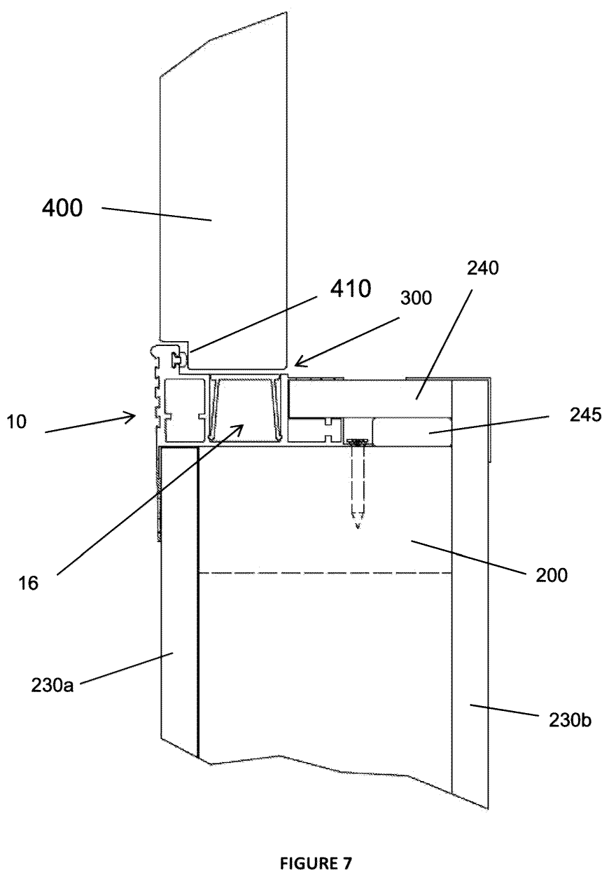

The door jamb assembly 100 comprises a frame profile 10 which is used to form the side jambs 110 and the head jamb 120. The frame profile 10 is an elongated extrusion having a consistent cross section along its length, which is cut to the required lengths for the side jambs 110 and head jamb 120. The following description refers to the cross-section profile of the frame profile 10 as shown in FIG. 5.

In cross-section, the frame profile 10 comprises a base plate 12 having a first face 14, a second face 16, a first side edge 18 and a second side edge 20. A wall attachment flange 22 extends from the first side edge 18 generally perpendicularly to the second face 16. The second face 16 and the wall attachment flange 22 form a structure engagement space 24 therebetween.

A first formation 30 extends from the first face 14 adjacent the first side edge 18, and a second formation 50 extends also from the first face 14 close to the second side edge 20 but spaced therefrom. The first formation 30 is spaced from the second formation 50 which defines a main channel 60 therebetween.

The first formation 30 is generally hollow rectangular in cross-section and includes a first side 32, an opposite second side 34, and a third side 36. The first side 32 extends generally perpendicularly to the first face 14 at the first side edge 18. The second side 34 also extends generally perpendicularly to the first face 14, parallel to and spaced from the first side 32. The third side 36 extends generally between distal edges of the first side 32 and the second side 34. A section of the base plate 12 opposite to the third side 36 defines a fourth side of the first formation 30.

The first formation 30 includes an extension rib 37 extending from the junction between first side 32 and the third side 36. The extension rib 37 includes an outer face 38 which has decorative channels 39. The channels 39 are also formed on an outer face of the first side 32. The extension rib 37 further includes an inside face which has a retaining channel 41 for receiving a felt or rubber strip in use. Elongated tabs 42 extend from respective inner surfaces of the first side 32 and the second side 34, which forms connector first insertion apertures 43.

The second formation 50 comprises a main side 52 which also extends generally perpendicularly to the first face 14, parallel to and spaced from the second side 34 of the first formation 30. The main side 52 is co-extensive in length as the second side 34 from the first face 14. The main side 52 of the second formation 50 and the second side 34 of the first formation 30 form the main channel 60 therebetween, with retention grooves 62 formed at the lower portions of the main side 52 and the second side 34 adjacent the base plate 12.

A hollow rectangular frame section 72 extends from the main side 52 and the first face 14. The frame section 72 is spaced from the second side edge 20, and defines second insertion apertures 73 therewithin. Elongated tabs 79 extend from respective inner surfaces of the frame section 72. An extension 74 extends laterally from the main side 52, parallel to the first face 14, towards the second side edge 20. The extension 74 forms a trim receiving space 75 with the main side 52 and the frame section 72. The trim receiving space 75 is thus a channel parallel to the base plate 12 for receiving a trim board therein which will be parallel to the base plate 12. The portion of the base plate 12 between the frame section 72 and the second side edge 20 defines an attachment tab 76 which can have spaced attachment apertures therein.

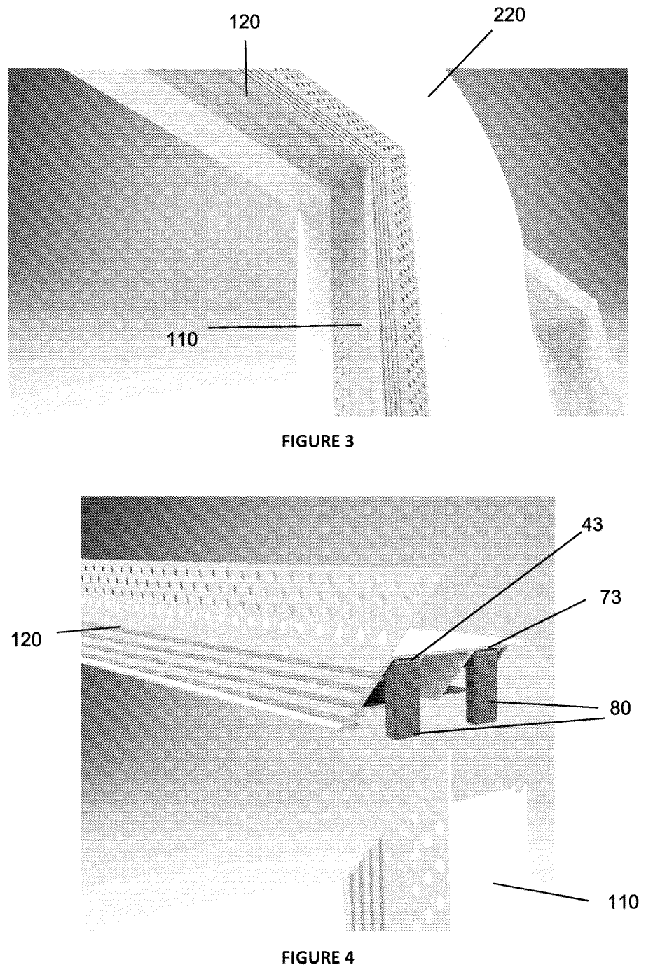

As shown in FIGS. 2 to 4, sections of the elongate frame profile 10 are cut to the required lengths to form the hinge side jamb 110a, the head jamb 120 and the latch side jamb 110b. The ends of the frame profile 10 are mitre cut at 45° to form the 90° corners between the head jamb 120 and the side jambs 110. Corner connectors 80 which have two legs at 90° to each other are inserted into the connector first insertion apertures 43 and second insertion apertures 73 to assist with connection and alignment between the head jamb 120 and the side jambs 110.

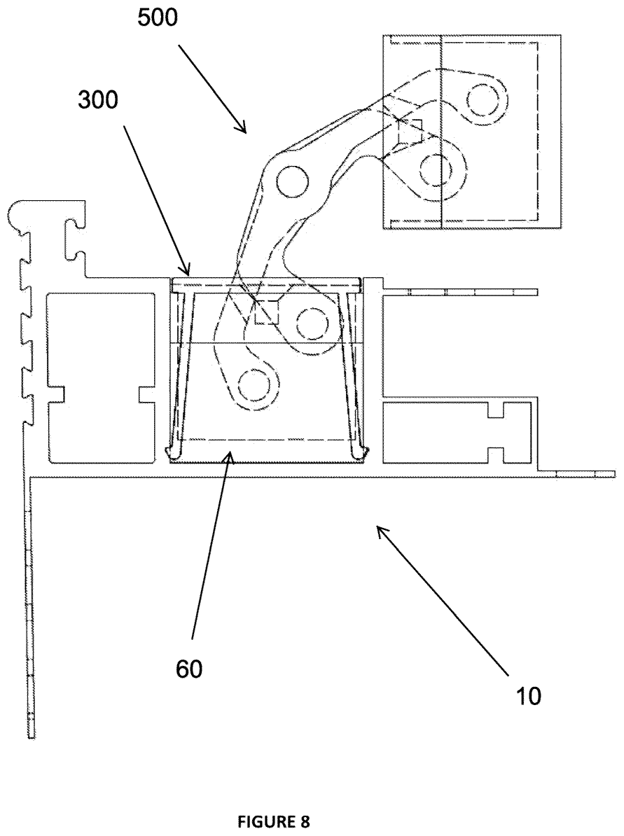

FIG. 6 shows attachment of the frame profile 10 to a stud 200 to form the latch side jamb 110a. A wall 190 of the structure includes the stud 200 having a front face 210 and side faces 220. Wall boards 230 are attached to the side faces 220, being a front wall board 230a and a rear wall board 230b. The wall covers 230 are typically plasterboards.

The front wall board 230a terminates aligned with the front face 210 of the stud 200. The front wall board 230a and the stud 200 are received in the structure engagement space 24 of the frame profile 10 with the wall attachment flange 22 extending across an outer face of the front wall board 230a. The base plate 12 typically extends short of the width of the stud 200, and is attached to the stud 200 via fasteners 77 through the attachment tab 76.

The rear wall board 230b extends past the stud 200 to substantially align with the extension 74. A trim board 240 is received in the trim receiving space 75 and extends to an inside surface of the rear wall board 230b. A packer 245 is disposed between the stud 200 and the trim board 240 to support and maintain the trim board 240 parallel. The trim board 240 is supported at one edge thereof by the frame section 72 and at the other edge thereof by the packer 245. The trim board 240 extends the full length of the stud 200 whilst the packer 245 can also extend the full length or be in the form of short, spaced sections.

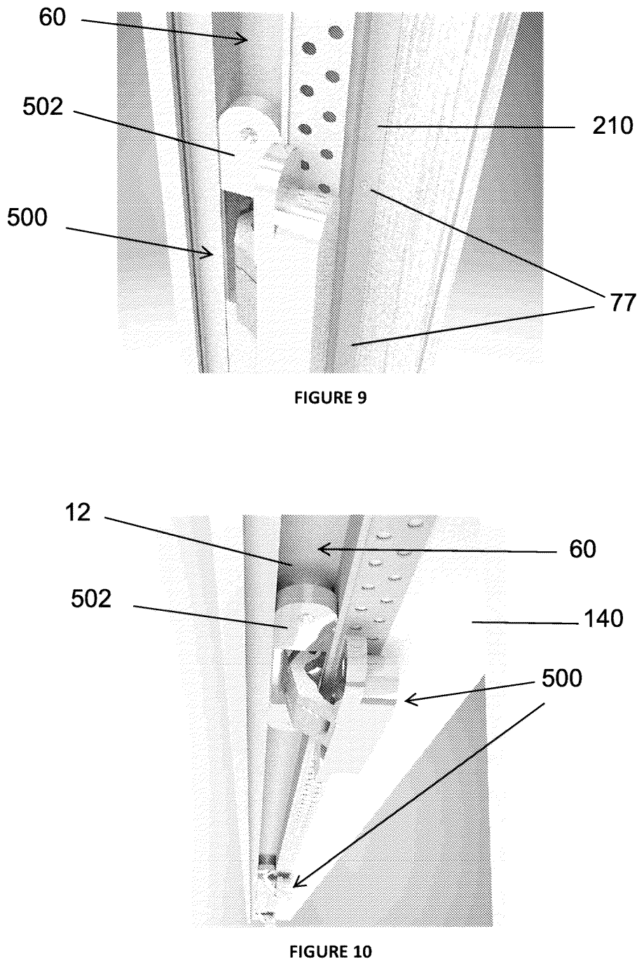

An elongated clip-on cover 300 having an outer side 302 and flange legs 304 is inserted into the main channel 60. The flange legs 304 include ribs 306 at the lower outer ends thereof which engage the retention grooves 62 of the main channel 60. The flange legs 304 are of a length such that the outer side 302 is substantially aligned with the third side 36 of the first formation 30 and the extension 74, and thus also the trim board 240 when installed. An elongated right angle corner trim 310 is mounted to cover the junction between the rear wall board 230b and the trim board 240. A felt or rubber strip 320 is mounted to the retaining channel 41 of the extension rib 37 for engagement by the door 400. The door 400 can include a rebate 410 for receiving the extension rib 37. FIG. 7 shows an embodiment with a shorter rebate 410 of the door 400.

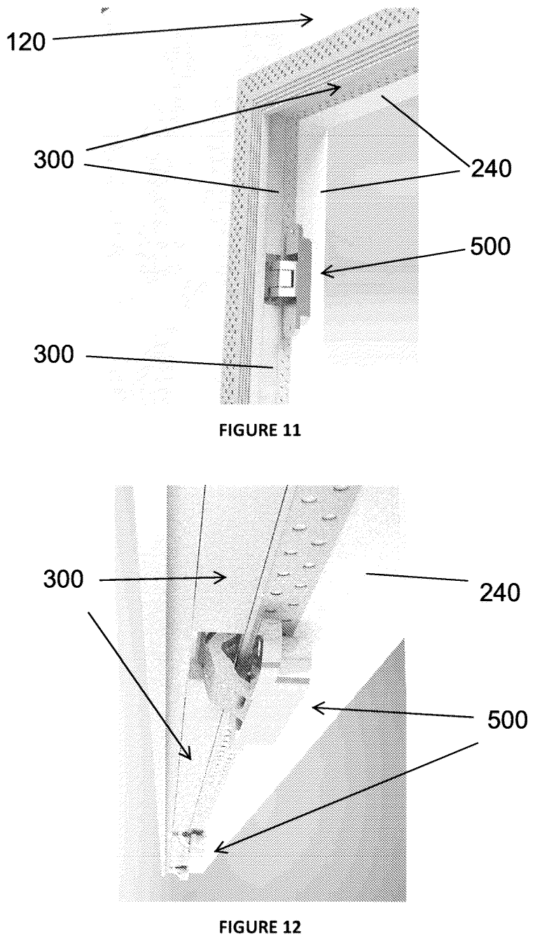

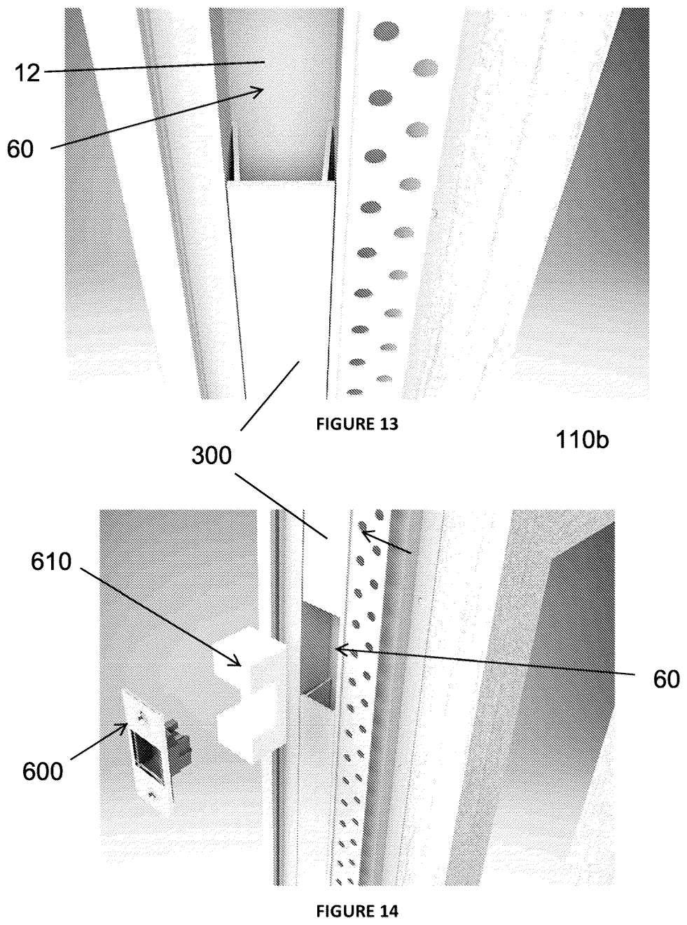

FIGS. 8 to 12 show attachment of a hinge 500 to a hinge side jamb 110a. The hinge 500 is a 3D concealed hinge type which is received and mounted in the main channel 60. The hinge 500 includes mounting tabs 502 which are attached via fasteners to the stud 200 through the base plate 12. The hinges 500 are mounted spaced along the main channel 60. Sections of clip-on cover 300 are then inserted to cover the parts of the main channel 60 not having the hinges 500. The clip-on covers 300 also cover the mounting tabs 502.

As shown in FIG. 11, the head jamb 120 has the main channel 60 thereof covered by the clip-on cover 300.

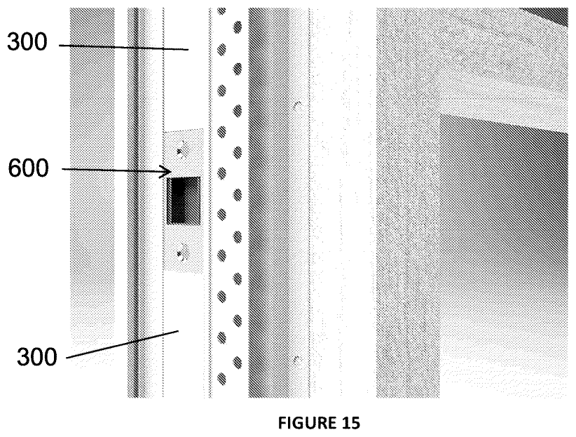

FIGS. 13 to 15 show attachment of a latch 600 to a latch side jamb 110b. The latch 600 is mounted via a spacer 610 in the main channel 60 via fasteners to the stud 200 through the base plate 12. Sections of clip-on cover 300 are then inserted to cover the parts of the main channel 60. The latch 600 sits flush with the clip-on covers 300.

The invention provides a frame profile with a main channel which can be cut to required lengths. The main channel provides flexibility of function at it can receive hinges, latches, etc. with no restrictions as to their position along the main channel. Sections of the main channel which are not used can be covered with the clip-ion covers. The invention thus provides a door jamb system typically for an “inswing” door where the door is pushed to open instead of pull to open. The system in the preferred embodiment uses a concealed hinge system which is housed into a channel of the frame profile with an aluminium clip infill piece to cover the channel. The frame profiles are cut to size to form the side jambs and the head jamb. The frame profile allows the system to be adaptable to any wall thickness as it is not a fixed throat design that is made to suit a certain wall thickness. Changes in wall thickness are adapted by changing the width of the trim board as needed. The design is universal and can be used in all markets, USA, UK, Europe, etc.

Also, the door can be a left hand swing or right hand swing depending on which side the user wants to install the hinges and the finish can be totally square set or have a 10×10 mm shadowline around the door face by creating a 10×20 mm groove. A fur felt strip will be installed in the groove on the door stop to reduce noise when the door is closed.

Whilst preferred embodiments of the present invention have been described, it will be apparent to skilled persons that modifications can be made to the embodiments described.

We claim:

1. A frame profile, being an elongated extrusion having a consistent cross section along its length which can be cut to required lengths for forming side jambs and/or a head jamb of a door, the frame profile comprising:
a base plate having a first face, a second face, a first side edge and a second side edge,
a first formation extending from the first face adjacent the first side edge, and
a second formation extending from the first face close to the second side edge, the second formation being spaced from the first formation to define a main channel therebetween,
wherein the second formation is comprised of a trim receiving space for receiving a trim board therein.

2. The frame profile of claim 1, further comprising: a wall attachment flange extends from the first side edge and perpendicularly to the second face to form a structure engagement space therebetween.

3. The frame profile of claim 1, wherein the second formation is spaced from the second side edge to define an attachment tab.

4. The frame profile of claim 1, wherein the first formation is comprised of a hollow rectangular in cross-section and having a first side extending perpendicularly to the first face at the first side edge, a second side extending perpendicularly to the first face and parallel to and spaced from the first side, and a third side extending between distal edges of the first side and the second side, the first formation having an extension rib along the first side thereof, the extension rib having a retaining channel for receiving a felt or rubber strip in use.

5. The frame profile of claim 4, wherein the first formation defines connector first insertion apertures therein.

6. The frame profile of claim 4, wherein the second formation comprises a main side which extends perpendicularly to the first face of the base plate, parallel to and spaced from the second side of the first formation to form the main channel therebetween.

7. The frame profile of claim 6, wherein the main side is co-extensive in length from the first face as the second side of the first formation.

8. The frame profile of claim 6, wherein the main side of the second formation and the second side of the first formation form the main channel therebetween with retention grooves adjacent lower portions of the main side and the second side adjacent the base plate.

9. The frame profile of claim 6, wherein the second formation further comprises a hollow rectangular frame section extending from the main side and the first face the frame section defining second insertion apertures therewithin.

10. The frame profile of claim 9, further comprising: an extension extending laterally from the main side, parallel to the first face and towards the second side edge, the extension forming the trim receiving space with the main side and the frame section.

11. The frame profile of claim 8, further comprising an elongated clip-on cover having an outer side and flange legs for insertion into the main channel, the flange legs including ribs at the lower outer ends thereof which engage the retention grooves of the main channel.

12. A method of forming a side jamb and a head jamb using the frame profile of claim 1, the method comprising the steps of:
cutting sections of the elongate frame profile to the required lengths to form the side jamb and the head jamb, the ends of the frame profiles being mitre cut at 45° to form the 90° corners between the head jamb and the side jamb.

13. The method of claim 12, further comprising the steps of:
inserting corner connectors which have two legs at 90° to each other into the connector first insertion apertures and second insertion apertures to connect and align the head jamb and the side jamb.

14. The method of claim 12, further comprising the step of:
installing a hinge in the main channel.

15. The method of claim 12, further comprising the step of:
installing a latch in the main channel.

16. The method of claim 12, further comprising the step of:
covering the main channel with an elongated clip-on cover having an outer side and flange legs for insertion into the main channel, the flange legs being comprised of ribs at the lower outer ends thereof which engage the retention grooves of the main channel.
